(19) United States
(12) Patent Application Publication
(10) Pub. No.: US 2012/0133625 A1
(43) Pub. Date: May 31, 2012

(54) METHOD FOR DRIVING CHOLESTERIC LIQUID CRYSTAL DISPLAY DEVICE

(75) Inventors: Bao-Sian Ciou, Sanchong City (TW); Sheng-fa Liu, Zhudong Township (TW); Yu-hsien Chen, Kaohsiung City (TW); Huai-an Li, Zhongli City (TW); Chun-yu Shen, Yuanlin Township (TW)

(73) Assignee: CHUNGHWA PICTURE TUBES, LTD., Bade City (TW)

(21) Appl. No.: 13/052,019

(22) Filed: Mar. 18, 2011

(30) Foreign Application Priority Data
Nov. 30, 2010 (TW) 099141571

(51) Int. Cl. G09G 5/00; G09G 3/36

(52) U.S. Cl. 345/208; 345/87

(57) ABSTRACT

A method for driving a cholesteric liquid crystal display device is disclosed. The cholesteric liquid crystal display device includes a plurality of pixels. The method includes steps below. In a first duration, a first square wave is provided for the pixels. The first square wave has an amplitude of a first value. In a second duration, a second square wave is provided for each one of the pixels according to a required gray level of each one of the pixels. The second square wave has an amplitude of a second value. The second value is different from the first value. The first square wave and the second square wave are continuously provided. The method for driving the cholesteric liquid crystal display device according to the present invention is capable of displaying a motion picture and decreasing driving voltages.

### BACKGROUND OF THE INVENTION

1. Field of the Invention

The present invention generally relates to a driving method, and more particularly to a method for driving a cholesteric liquid crystal display device.

2. Description of Prior Art

When there is no driving voltage being applied to cholesteric liquid crystals, the cholesteric liquid crystals can be in one of two stable states: a planar state (also called a planar texture), and a focal conic state (also called a focal conic texture). Accordingly, the cholesteric liquid crystals are a type of bistable material. In a cholesteric liquid crystal display device, the cholesteric liquid crystals in the planar state reflect incident light having a specified wavelength, therefore pixels corresponding to the cholesteric liquid crystals in the planar state appear to be in a bright status. When the cholesteric liquid crystals are in the focal conic state, the incident light is scattered and absorbed by a black back plate which is disposed in the back of the cholesteric liquid crystals and thus the pixels corresponding to the cholesteric liquid crystals appear to be in a dark status. Since the cholesteric liquid crystals are capable of being maintained in one of the two stable states in a situation where no driving voltage is applied, the cholesteric liquid crystals are suitable to be employed in a device which does not often refresh a frame, such as an electronic book (also called e-book). Furthermore, a threshold voltage is a voltage required to drive the cholesteric liquid crystals from the focal conic state to the planar state. A process for the cholesteric liquid crystals to be converted from the focal conic state to the planar state is regarded as a homeotropic state.

Please refer to FIG. 1, which illustrates a general waveform diagram of a driving voltage of the cholesteric liquid crystals. In a preparing duration, a preparing voltage VP is provided to drive the cholesteric liquid crystals into the planar state so as to refresh a frame. The preparing voltage VP is at least greater than or equal to the aforementioned threshold voltage VTH which is required to drive the cholesteric liquid crystals from the focal conic state to the planar state. The preparing duration is in a range from about 10 milliseconds (ms) to about 100 ms according to different types of cholesteric liquid crystals. Then, there is no voltage provided in a first waiting duration. The first waiting duration is a period of time for the cholesteric liquid crystal to be converted from the homeotropic state to the planar state. The first waiting duration is usually in a range of about milliseconds. Next, a selecting voltage VS is provided in a selecting duration to drive one of the pixels to display a required gray level. That is, the selecting voltage VS is a driving voltage for the pixel. The selecting duration is in a range from about 10 ms to about 100 ms. A second waiting duration at the end is a period of time for waiting the cholesteric liquid crystals to be stable to display a required picture. Since the preparing voltage VP and the selecting voltage VS are discontinuously provided, in addition, two waiting durations are required, a total time of the preparing duration, the first waiting duration, the selecting duration, and the second waiting duration is at least 1 second. That is, at least 1 second is required to drive one pixel. If one frame of picture is composed of one thousand pixels, 1000 seconds are required for refreshing the picture. Accordingly, no matter in an active matrix (AM) display device or a passive matrix (PM) display device, the time for refreshing a picture is too long.

Please refer to FIG. 2, which illustrates a three-duration waveform diagram of a driving voltage of the cholesteric liquid crystals. The three-duration waveform comprises a preparing duration, a selecting duration, and an evolution duration. In the preparing duration, a preparing voltage VP is provided to drive the cholesteric liquid crystals into the planar state so as to refresh a frame. The preparing duration is about 50 ms. In the selecting duration, a selecting voltage VS is provided to drive one of the pixels to display a required gray level. The selecting duration is about 1 ms. In the evolution duration, an auxiliary voltage VE is provided to drive said one of the pixels to reach the required gray level faster and more stably. The evolution duration is about 50 ms. The three-duration driving waveform is capable of providing a fastest frame refresh time in the passive matrix display device. The driving time of the cholesteric liquid crystals is different according to different types of cholesteric liquid crystals, but the frame refresh time can be controlled between 1 second to 2 seconds (for 1000 data lines). Although the three-duration driving waveform is capable of decreasing the frame refresh time significantly, the selecting duration is too short to drive the cholesteric liquid crystals into a best state, i.e. the bright status is not bright enough and the dark status is not dark enough. As a result, performance of a part of the display image is affected. Further, the three-duration driving waveform is only suitable to be employed in the passive matrix display device but cannot be employed in the active matrix display device, and thus displaying a motion picture (video) fails to be implemented.

Please refer to FIG. 3, which illustrates a two-duration waveform diagram of a driving voltage of the cholesteric liquid crystals. A difference between the two-duration waveform and the three-duration waveform in FIG. 2 is that the auxiliary voltage VE in FIG. 2 is not provided in the two-duration waveform in FIG. 3. Furthermore, in the three-duration waveform in FIG. 2, the selecting voltage VS is provided according to the required gray level of each pixel, that is, the respective pixels having different gray levels are driven by different selecting voltages VS. In contrast, the selecting voltage VS has a fixed value in the two-duration waveform in FIG. 3. If one preparing voltage VP and one selecting voltage VS are regarded as one time of input in the two-duration driving waveform, different gray levels are obtained by providing different times of inputs. Two methods for displaying different gray levels comprise providing the prepare voltage VP greater than the selecting voltage VS and providing the prepare voltage VP less than the selecting voltage VS. Please refer to FIGS. 4A-4B. FIG. 4A illustrates a relationship between four times of inputs (comprising one preparing voltage and one selecting voltage) and light reflectances when the selecting voltage VS is less than the preparing voltage VP. FIG. 4B illustrates a relationship between four times of inputs (comprising one preparing voltage and one selecting voltage) and light reflectances when the selecting voltage VS is greater than the preparing voltage VP. As can be seen from FIG. 4A, when the selecting voltage VS is less than the preparing voltage VP and the input (comprising one preparing voltage VP and one selecting voltage VS) is provided for more times, the light reflectance is lower and thus the choloesteric liquid crystals are converted from the planar state to the focal conic state. In another aspect, as can be seen from FIG. 4B, when the selecting voltage VS is greater than the preparing voltage VP and the input (comprising one preparing voltage VP and one selecting voltage VS) is provided for more times, the light reflectance is higher and thus the choloesteric liquid crystals are converted from the homeotropic state to the planar state. Generally speaking, at least 10 times of inputs (comprising one preparing voltage VP and one selecting voltage VS) are necessary so as to achieve optimal display performance (i.e. the lowest light reflectance or the highest light reflectance) in either FIG. 4A or FIG. 4B. The at least 10 times of inputs are at least 100 ms. Furthermore, when the driving time is too long, the cholesteric liquid crystals are slowly driven to another state. As a result, a black line problem occurs in a frame. Although refreshing one frame fast in the two-duration driving waveform is capable of making eyes neglect the black line problem, time of refreshing one frame still fails to be decreased. Therefore, the two-duration driving waveform can only display a static picture but fails to display a motion picture.

Therefore, there is a need to solve the above-mentioned problems.

### SUMMARY OF THE INVENTION

An objective of the present invention is to provide a method for driving a cholesteric liquid crystal display device which is capable of displaying a motion image.

According to an aspect of the present invention, the cholesteric liquid crystal display device comprises a plurality of pixels, and the method comprises steps below.

A first square wave is provided to the pixels in a first duration, and the first square wave has an amplitude of a first value.

A second square wave is provided to the pixels in a second duration according to a required gray level of each pixel, and the second square wave has an amplitude of a second value. The second value is different from the first value, and the first square wave and the second square wave are provided continuously.

The method for driving the cholesteric liquid crystal display device is capable of decreasing driving time of cholesteric liquid crystals so as to display a motion image, and decreasing driving voltages to implement an objective of decreasing power consumption.

### BRIEF DESCRIPTION OF THE DRAWINGS

FIG. 1 illustrates a general waveform diagram of a driving voltage of the cholesteric liquid crystals;

FIG. 2 illustrates a three-duration waveform diagram of a driving voltage of the cholesteric liquid crystals;

FIG. 3 illustrates a two-duration waveform diagram of a driving voltage of the cholesteric liquid crystals;

FIG. 4A illustrates a relationship between four times of inputs (comprising one preparing voltage and one selecting voltage) and light reflectances when the selecting voltage VS is less than the preparing voltage VP;

FIG. 4B illustrates a relationship between four times of inputs (comprising one preparing voltage and one selecting voltage) and light reflectances when the selecting voltage VS is greater than the preparing voltage VP;

FIG. 5 illustrates a flow chart of a method for driving a cholesteric liquid crystal display device according to the present invention;

FIG. 6 illustrates a waveform diagram of a driving voltage with a frequency of 100 Hz in accordance with the present invention;

FIG. 7 illustrates a curve indicating a relationship between a light reflectance of the cholesteric liquid crystals and a driving voltage;

FIG. 8 illustrates two curves which respectively indicate a relationship between the light reflectance of the cholesteric liquid crystals and the driving voltage with a frequency of 100 Hz in accordance with the waveform diagram in FIG. 1 and the waveform diagram of the present invention;

FIGS. 9A-9B illustrate waveform diagrams of a driving voltage with a frequency of 500 Hz and a frequency of 1000 Hz in the present invention; and

FIG. 10 illustrates three curves which indicate a relationship between the light reflectance of the cholesteric liquid crystals and the driving voltage with a frequency of 100 Hz, 500 Hz, and 1000 Hz in accordance with the waveform diagram of the present invention.

### DETAILED DESCRIPTION OF THE INVENTION

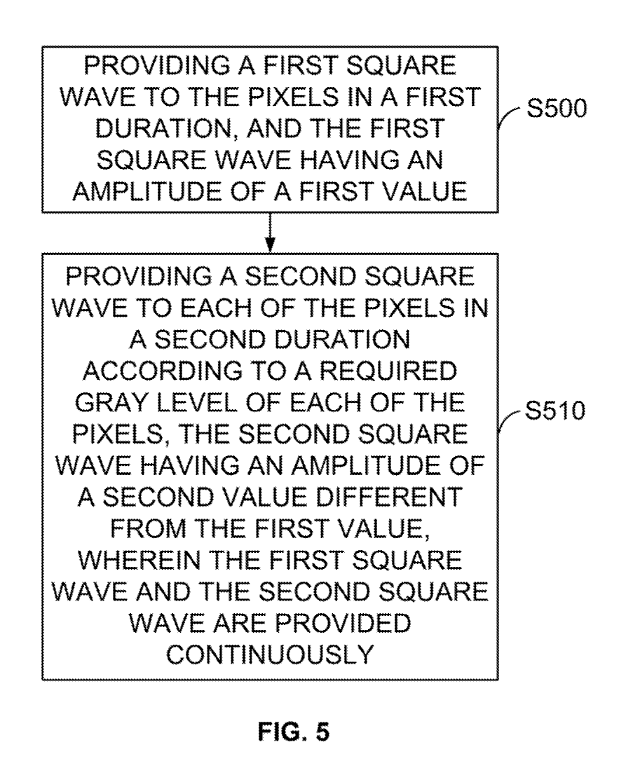

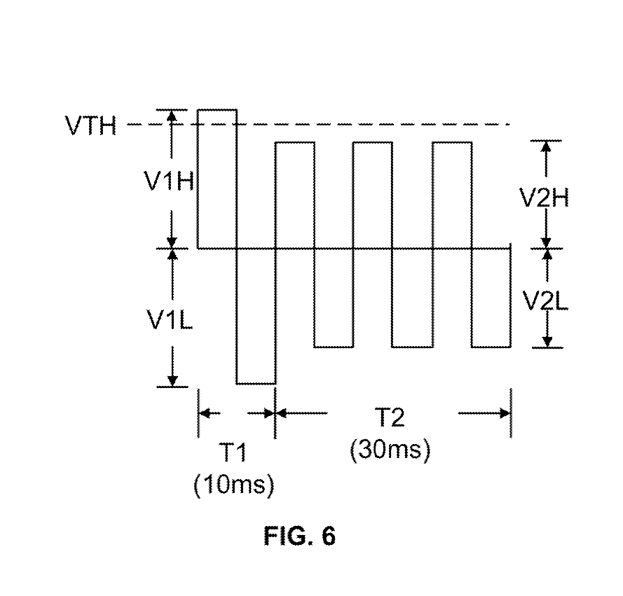

Please refer to FIGS. 5-6. FIG. 5 illustrates a flow chart of a method for driving a cholesteric liquid crystal display device according to the present invention. FIG. 6 illustrates a waveform diagram of a driving voltage with a frequency of 100 Hz in accordance with the present invention. The cholesteric liquid crystal display device comprises a plurality of pixels. The method comprises steps below.

In step S500, a first square wave having a first peak V1H and a first trough V1L is provided to the pixels in a first duration T. The first square wave has an amplitude of (V1H−V1L). An absolute value of the first peak V1H and an absolute value of the first trough V1L are greater than or equal to a threshold voltage VTH. The threshold voltage VTH is a voltage required for driving cholesteric liquid crystals of the cholesteric liquid crystal display device to return back to an initial planar state. The value of the threshold voltage VTH depends on the type of the cholesteric liquid crystals. A purpose of this step is to recover the cholesteric liquid crystals to the planar state so as to refresh a frame of a picture.

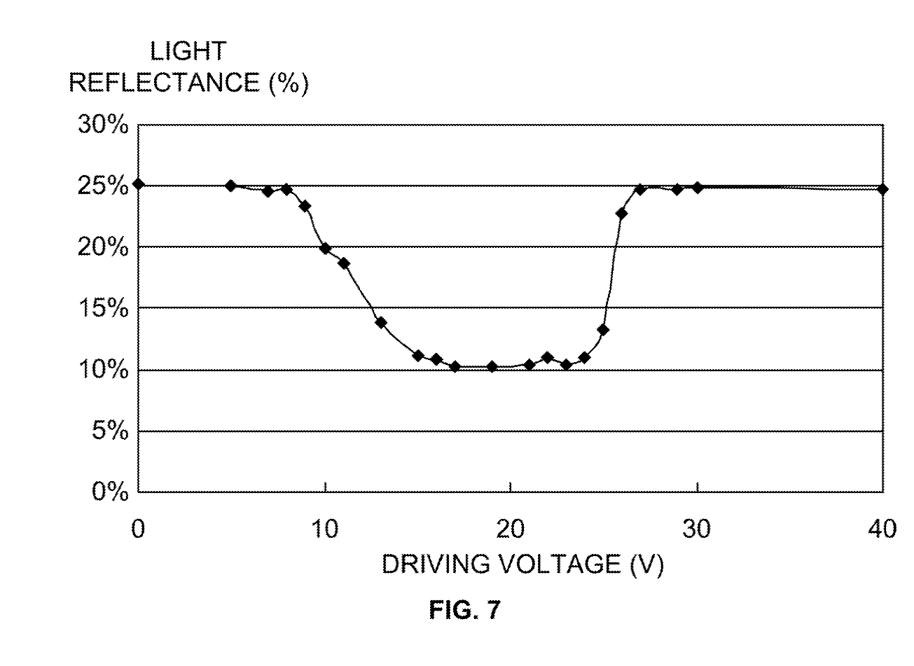

In step S510, a second square wave having a second peak V2H and a second trough V2L is provided to each of the pixels in a second duration T2 according to a required gray level of each of the pixels. That is, if the gray levels required to be displayed by the respective pixels are different, the second peaks V2H and the second troughs V2L of the second square waves provided to the respective pixels are different. The second square wave has an amplitude of (V2H−V2L). The value of (V2H−V2L) is different from that of (V1H+V1L), i.e. the amplitude of the second square wave is different from the amplitude of the first square wave. The first square wave and the second square wave are provided continuously. When the method of the present invention is implemented by an active matrix driving circuit, the second square waves are provided to the respective pixels at the same time. For example, when there are 1000 pixels, one thousand second square waves are respectively provided to the 1000 pixels at the same time. When the method of the present invention is implemented by a passive matrix driving circuit, the second square waves are sequentially provided to the respective pixels. For example, when there are 1000 pixels, the second square wave of the first pixel is provided to the first pixel, then the second square wave of the second pixel is provided to the second pixel, and so forth. The second peak V2H and the second trough V2L of the second square wave are determined based on FIG. 7. FIG. 7 illustrates a curve indicating a relationship between a light reflectance of the cholesteric liquid crystals and a driving voltage. For instance, when a gray level displayed by one of the pixels is corresponding to the light reflectance of 20%, the required driving voltage is about 10 volts (V) as shown in FIG. 7. That is, the second peak of the second square wave is +10V, and the second trough of the second square wave is −10V. Further, when a gray level displayed by another one of the pixels is corresponding to the light reflectance of 10%, the required driving voltage is about 20V as shown in FIG. 7. That is, the second peak V2H of the second square wave is +20V, and the second trough V2L of the second square wave is −20V. It is noted that the amplitude of the first square wave is greater than the amplitude of the second square wave in one preferred embodiment because the first square wave is the required voltage to drive the cholesteric liquid crystal to return back to the initial planar state. That is, the value of (V1H−V1L) has to be greater than the value of (V2H−V2L). In summary, when the pixels display different gray levels, the second peaks V2H and the second troughs V2L for the respective pixels are different based on FIG. 7. Furthermore, as can be seen from FIG. 7, a contrast ratio achieved by the present invention is:

$$\frac{maximum light reflectance}{minimum light reflectance} = \frac{25 \%}{10 \%} = 2.5 ,$$

which is much greater than a contrast ratio of 1.5 in the prior art.

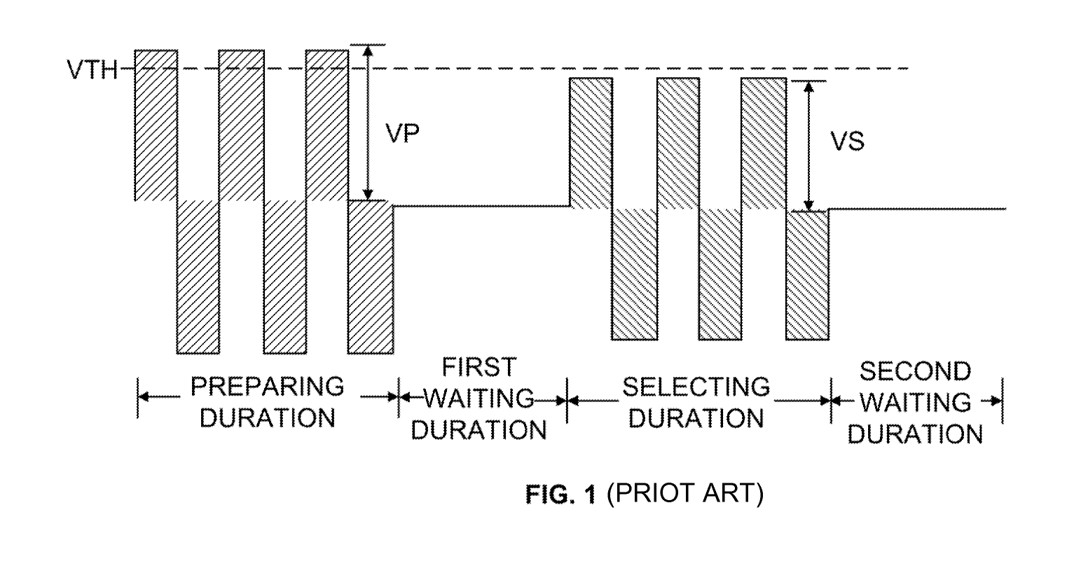

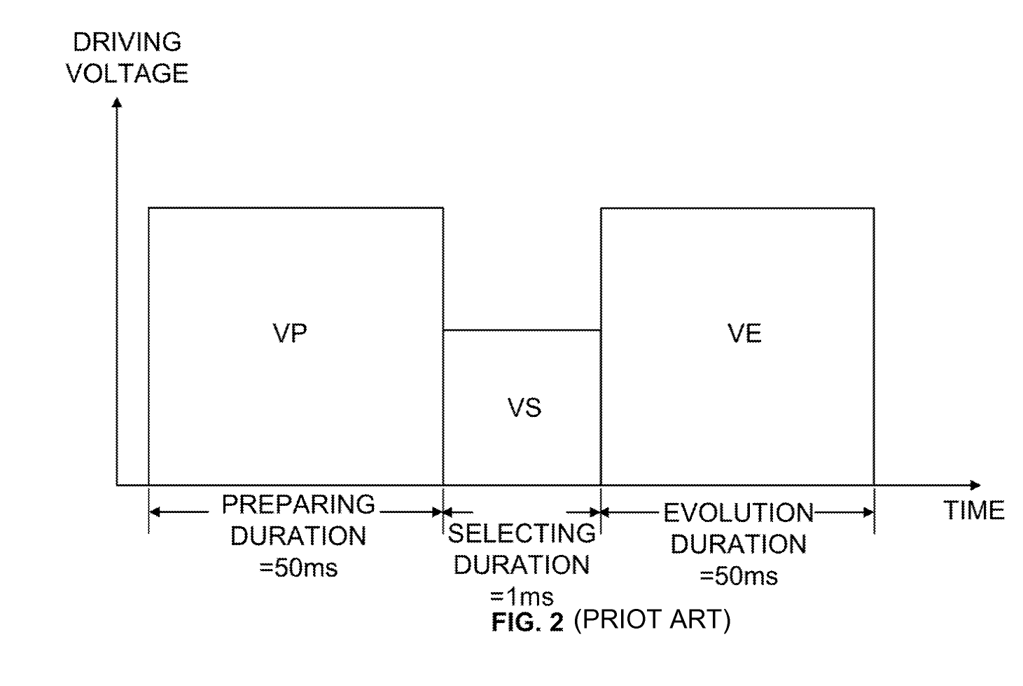

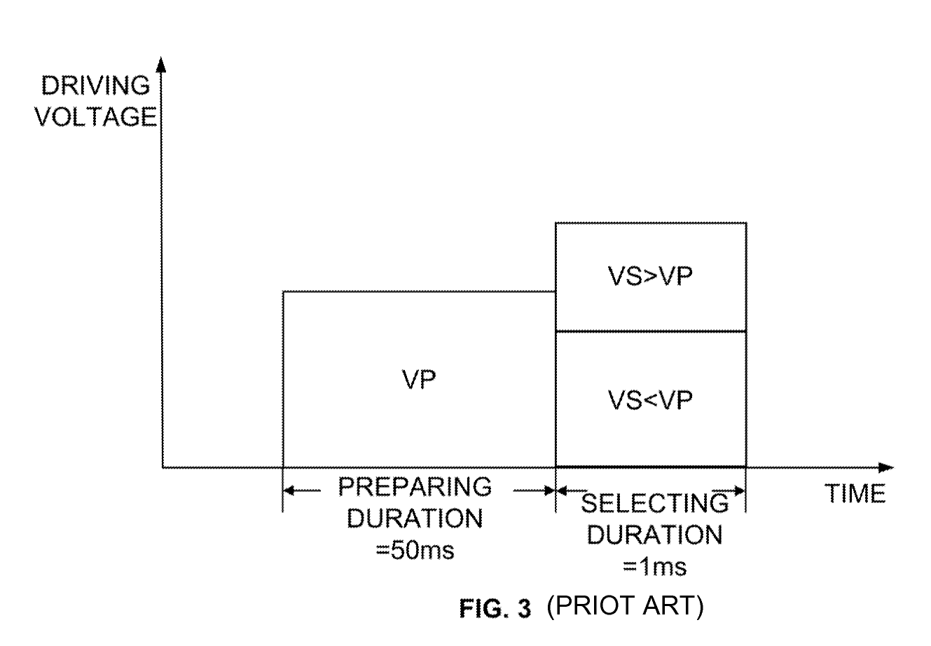

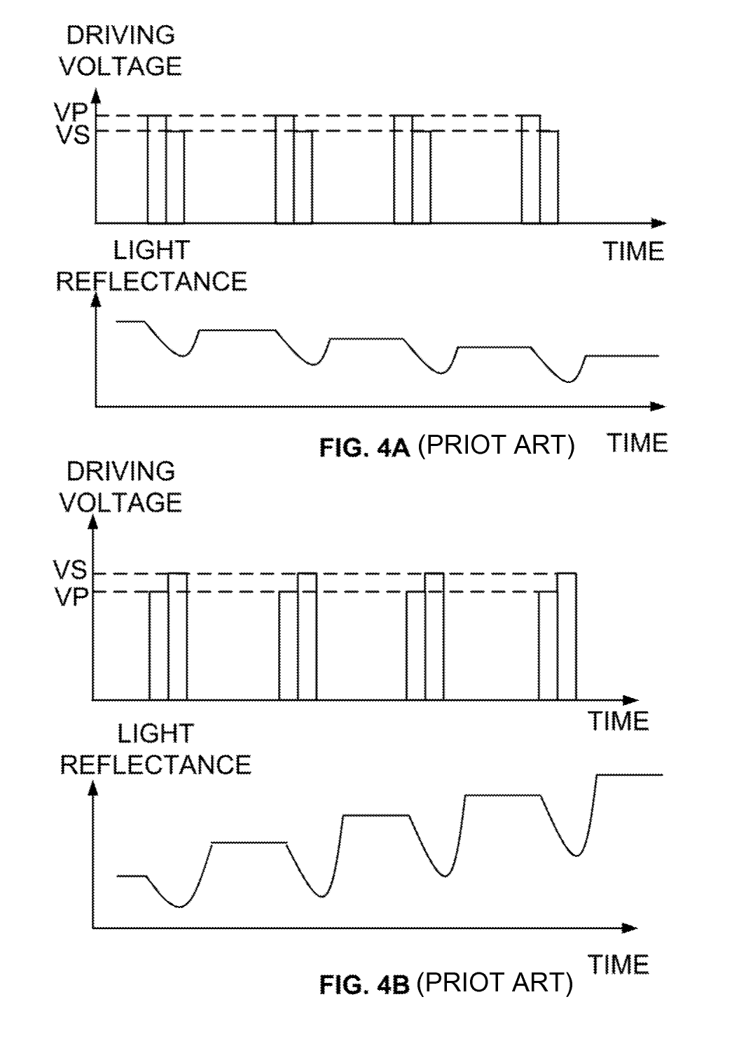

When the driving voltage has a frequency of 100 Hz, it is known from experiments that the optimal display performance can be achieved when the first square wave lasts for one cycle (10 ms) and the second square wave lasts for three cycles (30 ms). Compared with a driving time of 100 ms in the prior art, the driving time of 40 ms (10 ms+30 ms) is decreased significantly. Further, the first square wave and the second square wave are provided continuously without the first waiting duration and the second waiting duration shown in FIG. 1, and thus the driving time can be further reduced.

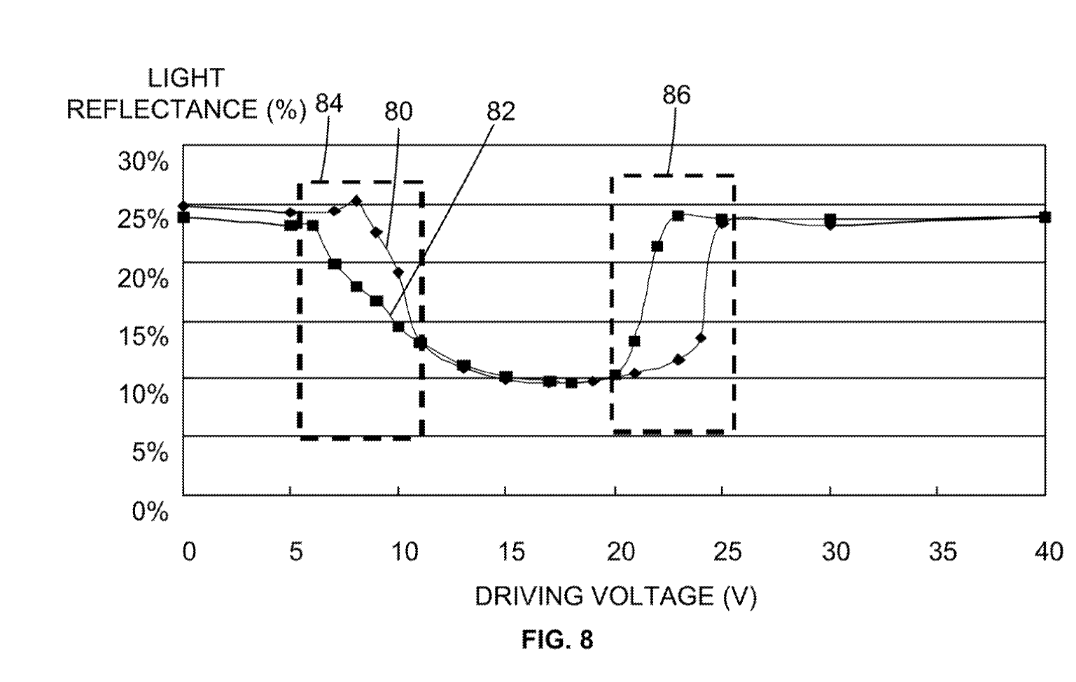

Please refer to FIG. 8. FIG. 8 illustrates two curves which respectively indicate a relationship between the light reflectance of the cholesteric liquid crystals and the driving voltage with a frequency of 100 Hz in accordance with the waveform diagram in FIG. 1 and the waveform diagram of the present invention. A curve 80 represents a relationship between the light reflectance of the cholesteric liquid crystals and the driving voltage with a frequency of 100 Hz in FIG. 1. A curve 82 represents a relationship between the light reflectance of the cholesteric liquid crystals and the driving voltage with a frequency of 100 Hz. In general, the cholesteric liquid crystals are driven to control the gray level in areas 84, 86. As shown in FIG. 8, the driving voltage of the curve 82 (the present invention) is lower than the driving voltage of the curve 80 (FIG. 1 in the prior art) in a range from 1V to 2V when the same light reflectance is required in either the area 84 or 86. As a result, the objective of decreasing power consumption can be implemented.

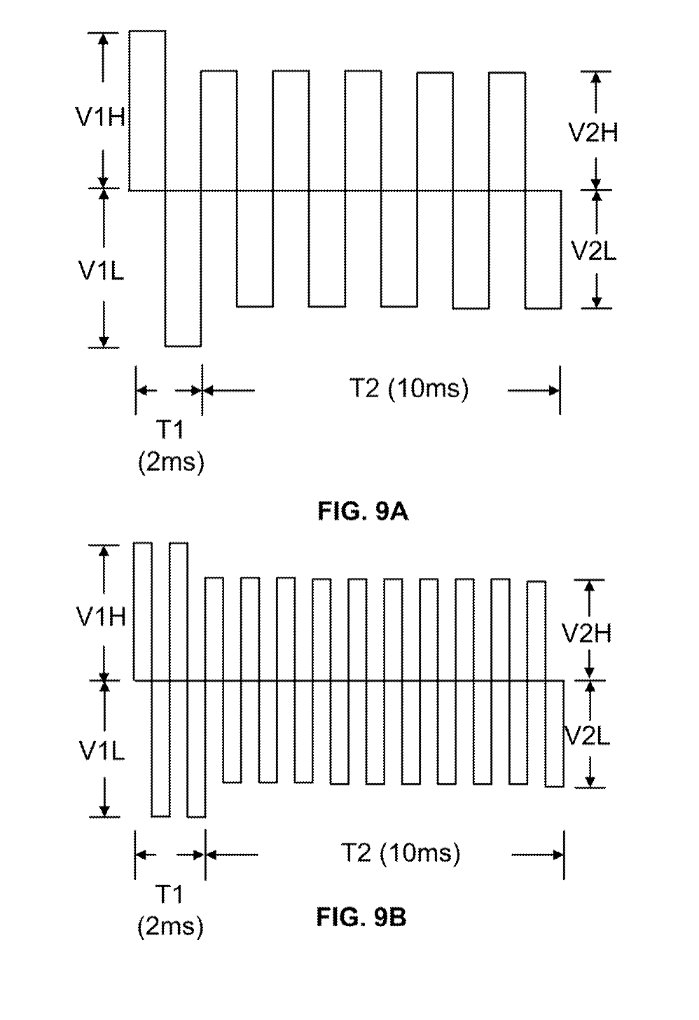

Furthermore, the method of the present invention can increase the driving frequency and decrease the driving time and the driving voltage. Please refer to FIGS. 9A-9B. FIGS. 9A-9B illustrate waveform diagrams of a driving voltage with a frequency of 500 Hz and a frequency of 1000 Hz in the present invention. When the driving voltage has a frequency of 500 Hz as shown in FIG. 9A, it is known from experiments that the optimal display performance can be achieved when the first square wave lasts for one cycle (2 ms) and the second square wave lasts for five cycles (10 ms). That is, the driving time is only 12 ms. When the driving voltage has a frequency of 1000 Hz as shown in FIG. 9B, it is known from experiments that the optimal display performance can be achieved when the first square wave lasts for two cycles (2 ms) and the second square wave lasts for ten cycles (10 ms). That is, the driving time is only 12 ms. In conclusion, when the driving frequency is at 500 Hz or 1000 Hz, the driving time can be decreased from 40 ms to 12 ms. If such a driving frequency (500 Hz or 1000 Hz) is implemented in the active matrix driving circuit, a motion picture can be displayed. If the motion picture is required to be displayed at 100 Hz, it is known from experiments that the first square wave lasts for one cycle (10 ms) and the second square wave lasts for one cycle (10 ms). The driving time is 20 ms. Compared with the driving time of 40 ms as shown in FIG. 6, the driving time of 20 ms lacks two cycles (20 ms) of the second square wave. Although the display performance is slightly deteriorating, the purpose of displaying the motion picture at 100 Hz can still be implemented.

As can be realized from FIGS. 6, 9A-9B, a ratio of cycles that the first square wave lasts to cycles that the second square wave lasts is between 1:1 and 1:5.

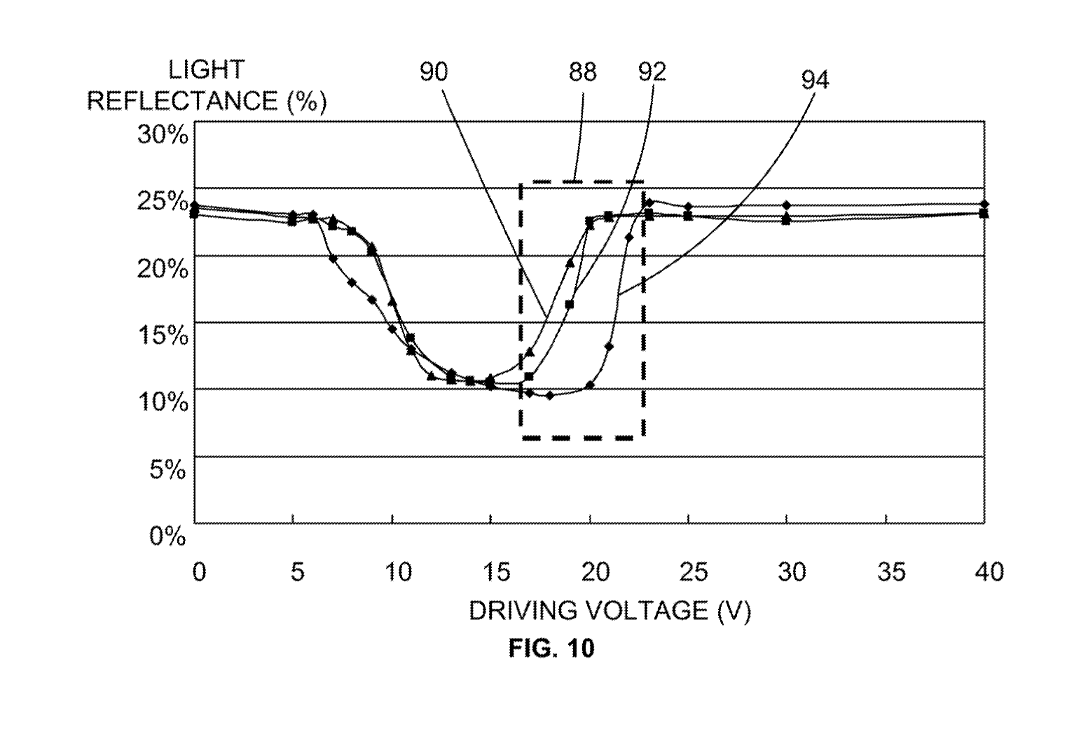

The reason for increasing the driving frequency and decreasing the driving voltage can be understood from FIG. 10. FIG. 10 illustrates three curves which respectively indicate a relationship between the light reflectance of the cholesteric liquid crystals and the driving voltage with a frequency of 100 Hz, 500 Hz, and 1000 Hz in accordance with the waveform diagram of the present invention. A curve 90 represents a relationship between the light reflectance of the cholesteric liquid crystals and the driving voltage with a frequency of 1000 Hz. A curve 92 represents a relationship between the light reflectance of the cholesteric liquid crystals and the driving voltage with a frequency of 500 Hz. A curve 94 represents a relationship between the light reflectance of the cholesteric liquid crystals and the driving voltage with a frequency of 100 Hz. When the light reflectance is controlled to be 15% in an area 88, the driving voltage of the curve 90 (at 1000 Hz) is 18V, the driving voltage of the curve 92 (at 500 Hz) is 19V, and the driving voltage of the curve 94 (at 100 Hz) is 21V. That is, the driving voltage is lower so as to decrease power consumption when the driving frequency is higher. Please refer to TABLE 1, which shows the driving time, the maximum light reflectance, the minimum light reflectance, and the contrast ratio at 1000 Hz, 500 Hz, and 100 Hz. It can be seen from TABLE 1, the maximum light reflectance, the minimum light reflectance, and the contrast ratio at 1000 Hz and 500 Hz are about the same as those at 100 Hz, and thus display performance is not affected.

TABLE 1

| driving frequency | 1000 Hz | 500 Hz | 100 Hz |
|---|---|---|---|
| driving time | 12 ms | 12 ms | 40 ms |
| maximum light reflectance | 23.52% | 23.18% | 23.95% |
| minimum light reflectance | 10.58% | 10.50% | 9.58% |
| contrast ratio | 2.223062 | 2.207619 | 2.5 |

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A method for driving a cholesteric liquid crystal display device, the cholesteric liquid crystal display device comprising a plurality of pixels, the method comprising:
providing a first square wave to the pixels in a first duration, and the first square wave having an amplitude of a first value; and
providing a second square wave to each of the pixels in a second duration according to a required gray level of each of the pixels, the second square wave having an amplitude of a second value different from the first value;
wherein the first square wave and the second square wave are provided continuously.

2. The method for driving the cholesteric liquid crystal display device as claimed in claim 1, wherein the second square waves of the pixels are provided to the respective pixels at the same time.

3. The method for driving the cholesteric liquid crystal display device as claimed in claim 1, wherein the second square waves of the pixels are sequentially provided to the respective pixels.

4. The method for driving the cholesteric liquid crystal display device as claimed in claim 1, wherein the first square wave has a first peak and a first trough, an absolute value of the first peak and an absolute value of the first trough are greater than or equal to a threshold voltage, which is a voltage required for driving cholesteric liquid crystals of the cholesteric liquid crystal display device into a planar state.

5. The method for driving the cholesteric liquid crystal display device as claimed in claim 1, wherein the first value of the amplitude of the first square wave is greater than the second value of the amplitude of the second square wave.

6. The method for driving the cholesteric liquid crystal display device as claimed in claim 1, wherein a ratio of cycles that the first square wave lasts to cycles that the second square wave lasts is between 1:1 and 1:5.

7. The method for driving the cholesteric liquid crystal display device as claimed in claim 1, wherein a frequency of the first square wave is at least greater than or equal to 100 Hz, and a frequency of the second square wave is at least greater than or equal to 100 Hz.

8. The method for driving the cholesteric liquid crystal display device as claimed in claim 7, wherein the frequency of the first square wave is 100 Hz, and the frequency of the second square wave is 100 Hz.

9. The method for driving the cholesteric liquid crystal display device as claimed in claim 8, wherein the first square wave lasts for one cycle, and the second square wave lasts for three cycles.

10. The method for driving the cholesteric liquid crystal display device as claimed in claim 8, wherein the first square wave lasts for one cycle, and the second square wave lasts for one cycle.

11. The method for driving the cholesteric liquid crystal display device as claimed in claim 7, wherein the frequency of the first square wave is 500 Hz, and the frequency of the second square wave is 500 Hz.

12. The method for driving the cholesteric liquid crystal display device as claimed in claim 11, wherein the first square wave lasts for one cycle, and the second square wave lasts for five cycles.

13. The method for driving the cholesteric liquid crystal display device as claimed in claim 7, wherein the frequency of the first square wave is 1000 Hz, and the frequency of the second square wave is 1000 Hz.

14. The method for driving the cholesteric liquid crystal display device as claimed in claim 13, wherein the first square wave lasts for two cycles, and the second square wave lasts for ten cycles.
